(19) United States
(12) Patent Application Publication
(10) Pub. No.: US 2002/0001414 A1
(43) Pub. Date: Jan. 3, 2002

(54) SYSTEM FOR BUILDING A DATA COMPRESSION ENCODER

(76) Inventor: RONI M SADEH, KFAR SABAH (IL)

Correspondence Address: MARK S COHEN, EITAN PEARL LATZER & COHEN-ZEDEK, CRYSTAL PARK, SUITE 210, 2011 CRYSTAL DRIVE, ARLINGTON,, VA, 22202, US

(21) Appl. No.: 09/165,535

(22) Filed: Oct. 2, 1998

(51) Int. Cl. G06K 9/36; G06K 9/46

(52) U.S. Cl. 382/250

(57) ABSTRACT

The present invention is embodied in a system for building a data compression encoder for use with the discrete cosine transform compression process. The invention results in enhanced compression using the discrete cosine transform by constructing a prediction engine that breaks the data received into predicted and unpredicted portions. The predicted portions are excluded from the discrete cosine transform reducing the time required to compress a file. The prediction engine relies, in part, upon look-up tables that are developed by the present invention to determine the predicted blocks. A table build engine and database compiler are used to create the look-up tables.

### BACKGROUND OF THE INVENTION

A. Field of the Invention

The invention is related generally to a system for building data compression devices and more particularly, to a system for building a data compression device for coding of images.

B. Description of the Prior Art

With the advent of high speed low cost microprocessors, there has been a rapid growth in the development of digital communication devices for the transmission of print, voice and video. The rapid growth and demand for such devices has quickly out paced the ability of the present communications hardware infrastructure to provide communications bandwidth to meet the digital communication demands. In the field of digital communications systems, the amount of data capable of being transmitted through a given media over time is referred to as bandwidth.

One solution to expand available bandwidth is through the implementation of data compression techniques to reduce the amount of digital data needed to represent the information transmitted. Digital compression techniques currently represent the most common solution for increasing the throughput of digital communications hardware. Given the variations in hardware technology and digital computer platforms that exist in various industries and internationally, standards have been established to provide certain data compression techniques that may be implemented universally.

In field of image information systems where images or pictures are represented in a digital form by data, numerous commercially accepted standards have been developed for compressing such digital images. One such standard was developed by the Joint Photographic Experts Group (JPEG), an international body formed to establish an international standard for the compression of grayscale and color images. This compression standard has come to be known as the JPEG standard in which digital images are compressed through an encoder and represented in a compressed form known as JPEG format. Images stored in the JPEG format have a file size which is significantly smaller than the file size of the same digital image stored in an uncompressed form. The JPEG standard was recommended by the International Telegraph and Telephone Consultative Committee (CCITT) as recommendation T.81 on Sep. 18, 1992 and was published by the International Standards Organization and International Electrotechnical Commission (ISO/IEC) as standard ISO 10918:1 entitled, “INFORMATION TECHNOLOGY—DIGITAL COMPRESSION AND CODING OF CONTINUOUS-TONE STILL IMAGES—REQUIREMENTS AND GUIDELINES ITU-T Rec. T.8|ISO 10918:1”.

The JPEG standard actually comprises two classes of compression processes, namely, lossy and lossless compression techniques. In lossy compression, substantial compression is achieved while some loss of the image data occurs when the image is subsequently decompressed. However, such losses in image quality may be so minimal that they are generally not considered discernable when viewed by the naked eye. Those processes that are based upon the discrete cosine transform (DCT) are considered lossy. An encoder 20 (FIG. 1) using lossy compression generally includes a DCT engine 21, a quantizer 22 and an entropy coder 26. These functions are defined in the JPEG standard. In the second class, lossless compression is achieved using an alternative technique to DCT in which no loss in image quality occurs when the image is decompressed. However, lossless compression does not achieve compression ratios as large as lossy compression. Thus, digital images when compressed under a lossless compression will have a greater file size and will take more time to transfer through a communications line than the same image when compressed over the lossy standard. Except in fields where image accuracy is desired, such as, in medical imaging where any change in the representation of an image containing human tissue may affect the diagnosis of an illness by a medical professional, most image applications can utilize the lossy compression standard for digital transmission.

In some real time applications, such as, transmitting digital images between facsimile machines, the JPEG standard for compressing digital images is more than capable of simultaneously compressing the data in conjunction with the transmission of the images. This is due to the fact that the narrow bandwidth of conventional analog phone lines for digital data transmission is inherently slower than other digital communications methods and provides more than adequate time for the simultaneous JPEG compression processes to occur in real time. However, in other hardware communications systems that have improved digital throughput or have been designed for digital transmission, such as computer buses and networks as well as digital television systems, the availability and need for even greater throughput and speed is in demand. In communications systems such as digital television transmission, it will be realized by those skilled in the art that the Moving Pictures Experts Group (MPEG) standard for compressing and transmitting moving picture images which is based upon the JPEG standard is also limited by this time constraint. Moreover, faster methods are needed for compressing and storing JPEG images prior to when image data is transferred, for example, to personal computers (PCs) from peripheral devices or for use with the storing of images in digital cameras and the like. When conventional JPEG compression processes are used in such environments in real time, the compression time needed to convert digital images into the JPEG standard using conventional JPEG compression methods can slow down the overall transmission rate of such high speed communications systems.

Thus, it may be appreciated that the time saved in transferring such compressed files has been reduced in part by the time needed by conventional compression techniques to encode a digital image into the JPEG file format. Such time constraints limit the effectiveness of the JPEG file format in applications that require the compression and transmission to occur quickly, simultaneously and/or in real time.

Thus, the need exists for encoding and decoding devices and processes that can convert digital images between an uncompressed and compressed file standard, such as JPEG or MPEG, in real time and without delay while operating with high speed communications systems.

### OBJECTS AND SUMMARY OF THE INVENTION

It is an object of the present invention to provide an image compression device and process that improves the conversion rates for encoding and decoding digital images between an uncompressed and compressed data standard.

It is another object of the present invention to provide an image compression device and process that improves conversion rates for digital transmission of compressed images using a lossy compression process.

It is yet another object of the present invention to provide an image compression device and process that reduces the time required for the discrete cosine transform (DCT) in the lossy compression process used to produce a compressed image under the JPEG standard.

An advantage of the present invention is the ability to provide a good quality image from a lossy compression process having improved compression rates.

Another advantage of the present invention is improved timing by eliminating DCT cycles not needed, but performed during conventional lossy compression.

A further advantage of the present invention is that it can be manufactured on an economical basis and has portability between various communication platforms.

A further advantage of the present invention is the capability to discriminate between types of uncompressed digital image data and to provide a lossy coding stage for a first set of image data and to perform conventional DCT on the second set of image data, thereby eliminating the need for use of the DCT on the first set of data.

It is a feature of the present invention to provide a compression device that may be tailored for application specific uses.

A database compiler for reading a plurality of images comprises a discrete cosine transform engine including means for apportioning said data when uncompressed into a plurality of uncompressed blocks and means for converting at least one of said blocks to a DCT coefficient block. The database also includes means for apportioning said DCT coefficient block into a plurality of predetermined groups. Additionally, means for comprising data values from a predetermined group to a predetermined characteristic is included. Finally, the compiler uses means for storing each successful comparison.

These and other objects and advantages of the invention will become apparent from the following more detailed description when taken in conjunction with the accompanying drawings of illustrative embodiments.

### BRIEF DESCRIPTION OF THE DRAWINGS

FIG. 1 is a block diagram of a JPEG encoder of the prior art.

FIG. 2 is a block diagram of the JPEG encoder of the present invention.

FIG. 3 is a block diagram of the encoder of the present invention.

FIG. 4 is a flow chart of a data compiler routine.

FIG. 5 is a flow chart of a table build routine.

FIG. 6 is a flow chart of a data compiler routine.

FIG. 7 is a table of a first group of data block cells representative of DCT coefficients.

FIG. 8 is a table of a second group of data block cells representative of DCT coefficients.

FIG. 9 is a table of a third group of data block cells representative of DCT coefficients.

FIG. 10 is a table of a fourth group of data block cells representative of DCT coefficients.

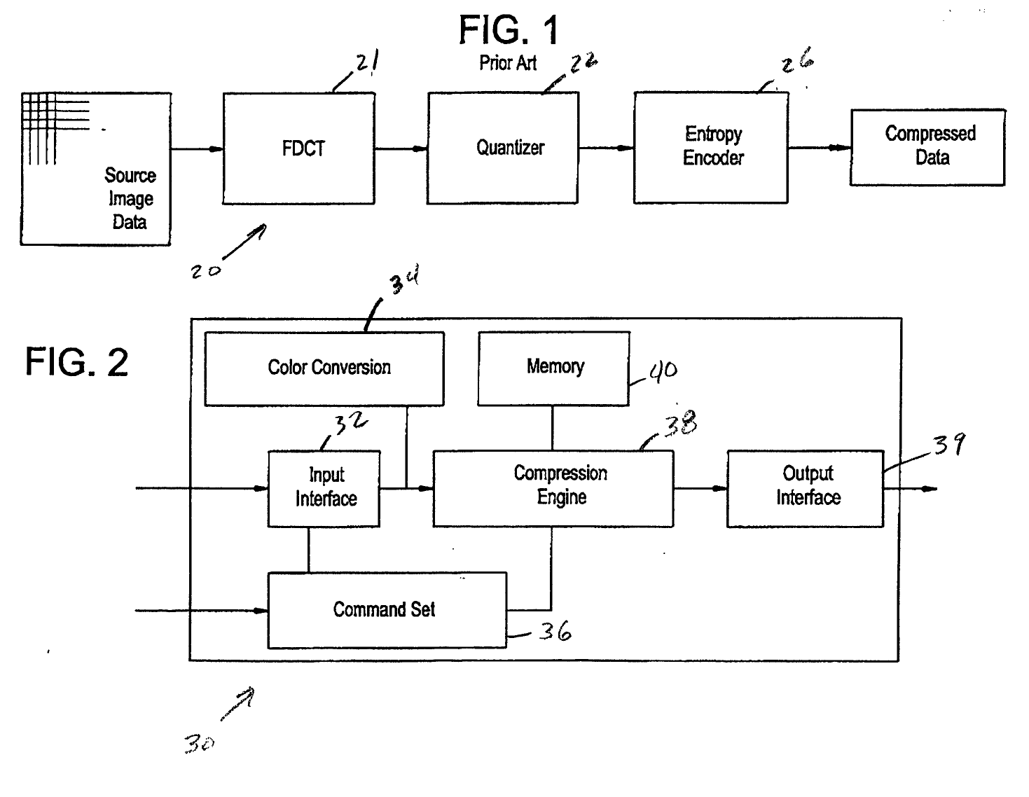

### DESCRIPTION OF THE PREFERRED EMBODIMENTS

In the following description, like reference numerals will be used to refer to like or corresponding elements in the different figures of the drawings for the purpose of illustration.

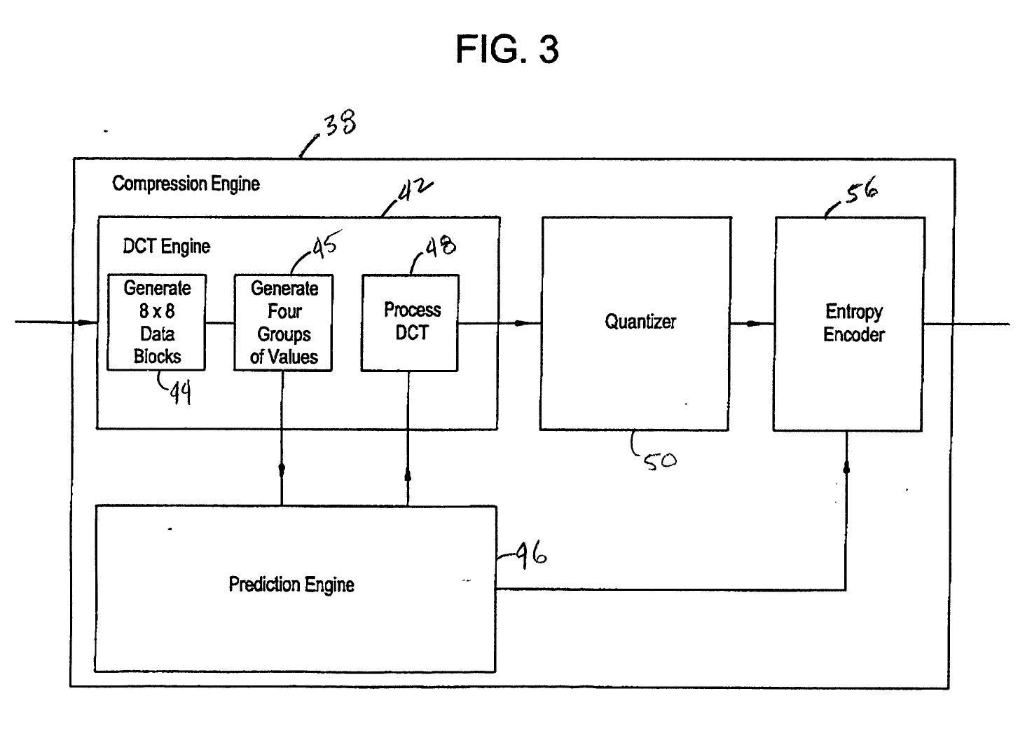

With reference to FIGS. 2 and 3, the present invention relates generally to an encoder 30 having an input interface 32 to receive images in the form of uncompressed digital data. Since the images may be represented in a variety of color formats, such as, RGB and CMYK formats, a color conversion driver 34 converts color images, if needed, into the YCbCr format for color images as used by the JPEG standard. A conventional command set 36 of data values which are user selectable and disclosed in the JPEG standard allow for the user to select certain criteria during the compression process which, for example, allows the user to adjust the degree of compression desired in relation to the quality of the image desired. A compression engine 38, connected to a memory 40, receives the YCbCr format image data and the command set data values and compresses the image data according to criteria determined by the command set data values. The memory 40 preferably includes the program software and data used by the compression engine 38 to perform the compression process. The compression engine 38 connects to an output interface 39 which transmits the image in the compressed JPEG format to other devices. The encoder 30 of the present invention can be implemented in either a software or hardware configuration. It will be appreciated that the input and output interface may cooperate with either software or hardware implemented devices independently from the hardware and/or software implementation of the encoder 30.

The present invention further relates to a compression engine 38 (FIG. 3) which includes a DCT engine 42 which operates to first divide the image data into 8×8 pixel blocks 44 and then initializes the data for DCT 45. In the case of color images, each 8×8 grouping of pixels contains three 8×8 blocks of pixels representing the each of the color channels YCbCr. These 8×8 data blocks are divided up from the image in a conventional manner in accordance with the JPEG standard. Advantageously, following the division of the image data in blocks, the conventional compression process using the DCT engine is interrupted.

A prediction engine 46 receives each of the 8×8 data blocks and operates to divide up the blocks, or groups of three blocks in the case of color images, into predicted blocks and non-predicted blocks. The non-predicted blocks are returned to the DCT engine in which the non-predicted blocks are operated upon conventionally using the DCT transform 48 and a quantizer 50 according to the conventional JPEG standard. Advantageously, predicted blocks do not receive subsequent processing under the conventional DCT engine 42. Rather, the predicted blocks are coded by a prediction coding engine 46 which assigns a predetermined JPEG compressed block for the predicted block. For each of the predicted blocks a substantial time savings is achieved by eliminating the conventional processing of the block using the DCT engine 42 in which the repetitive process required for the performing of the discrete cosine transform is eliminated. The time required for the prediction engine to operate is significantly less than the DCT process. Thus, even if only a few of the data values for an image are predicted, a significant time savings is achieved. An encoder of the type suitable for this purpose is disclosed in U.S. patent application Ser. No. ______ (Attorney Docket No. 1220-1-001 filed concurrently herewith) which is incorporated herein by reference.

Advantageously the system of the present invention relates to a compiler for building a prediction engine that has improved encoding speed and that may be tailored to work with application specific images. Specifically, the present invention relates to a prediction engine which utilizes a series of look-up tables.

As apparent to one of ordinary skill in the art, the prediction engine 46 generally performs a conventional look-up table process. The time saving performance achieved from prediction engine 46 is acquired from the simplicity of the prediction engine 46 steps and the creation of the look-up tables which allows for the prediction engine 46 process to predict non-zero blocks. It will further be appreciated that the look-up table may vary according to the application specific criteria such as whether the prediction engine is implemented in hardware and/or software. Further, the tables are tailored to the quantization method used.

In general, the following points have been discovered to be useful in creating the look-up tables:

1. The JPEG standard compresses information by assuming that certain combinations of DCT coefficients consist of more than 90% on average of the results in a given matrix of 8×8 DCT coefficients.

2. These common combinations are expressed by a small number of bits in the Hoffman table included in the entropy encoder.

3. Based on these facts, it is possible to select a small number of combinations for each group of 16 values as prepared, for example, by the DCT engine above.

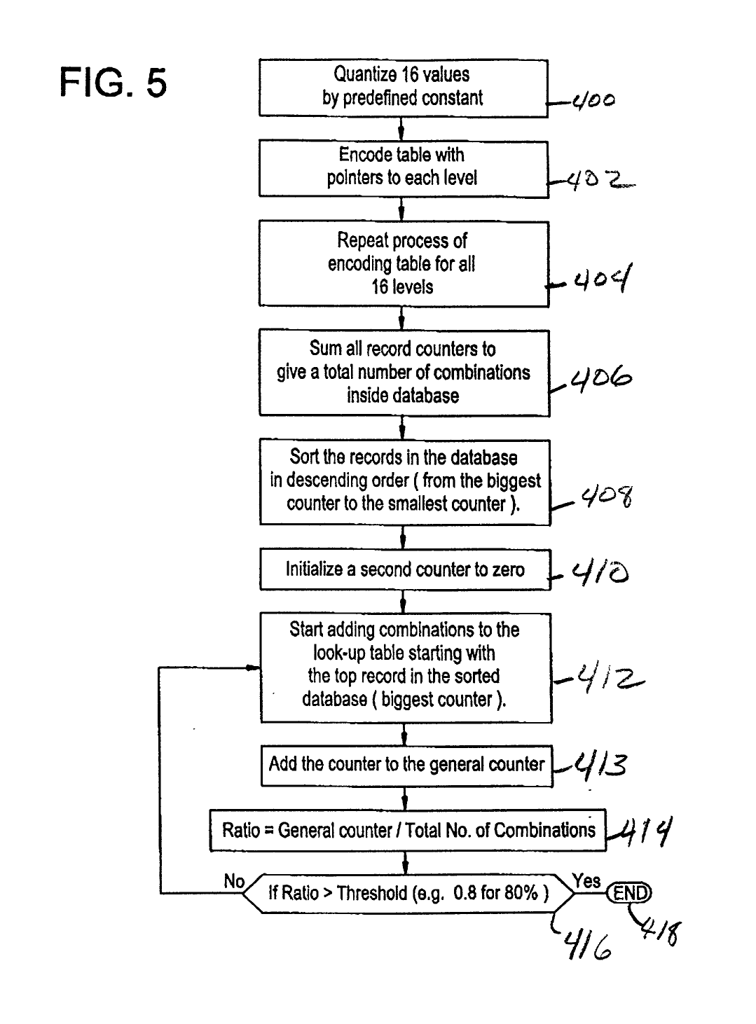

4. For each Group certain zero-one combinations defined as 12 values of any kind of combination that contains zeros, ones or minus ones for the “B” area FIG. 5 and higher combinations such as any kind of combination that contains numbers between seven and minus seven for the “A” area is considered good. Any number range will work, but selection of the range affects the memory usage. For ranges greater than −7 to 7, the improved performance is nominal in comparison to the increased memory usage.

5. The general rule for selecting the common combinations is based upon the JPEG Hoffman table provided by the JPEG Standard which provides a good statistical basis for the common combinations. For the “B” area, some of the common combinations consist of one coefficient being equal to 1 or −1 and the other 11 values of the 12 comprising the B area are zero. This occurrence provides a total of 24 combinations that share this common feature.

6. Surprisingly, it was discovered that, upon examining the 16 values that make up one of the four Groups, there are a relatively small number of common combinations that correspond to the common DCT combinations.

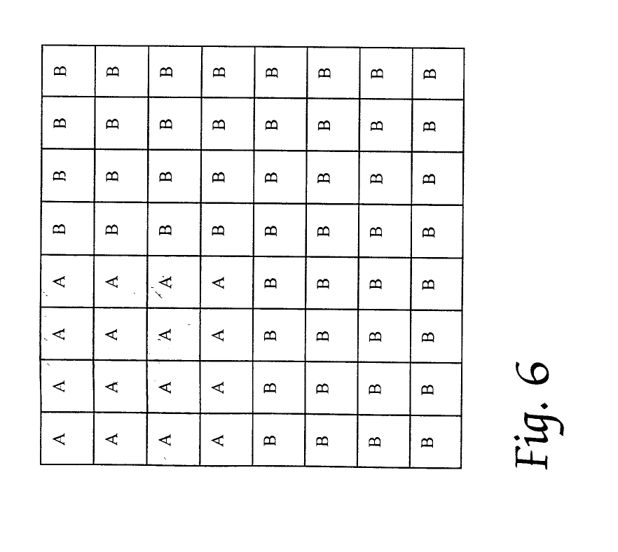

Using the above basic points as a guide what follows is a description of the process for creating a look-up table. For purposes of explanation the described look-up table corresponds to the A,B quantization table as illustrated by FIG. 6. It will be appreciated by those skilled in the art, that other tables may be generated applying the basic points listed above to other quantization tables. The process listed below corresponds to processing a single color image for a particular group and within a particular quantization table. However, in order to build up a table using this basic description, a large number of images should be processed under this method to produce a comprehensive coverage of common combinations. In selecting the images to be used the following criteria should be considered. Although any number and type of images are allowed it is clear that, the bigger the number of processed images and the wider the range of image types, the more accurate the statistical model. For applications that require a small range of image types, it would be best to process only images that belong to this category. For a general-purpose table for all types of images it would be best to cover all possible image types and from every category process at least 5 images. A good starting point for the general case is the test images supplied by the JPEG committee used in preparing the JPEG Standard. It is worth noting that the Hoffman tables supplied in the JPEG standard are optimized for a wide variety of image types and one can get the general idea of what are the most common combinations by examining these tables and extracting the codes with the smallest number of bits. However, it is not satisfactory to rely only on these tables because there is still a lot of redundant information inside. From experimentation, it is sufficient to process around 40-50 images with good coverage of all possible image types, to get an accurate statistical model.

The look-up table generator creates 8 databases of information from the scanned images. There are two databases for each of the four Groups: G(−)(−), G(−)(+), G(+)(−), G(+)(+) in which one data base contains a record of “Zero-One” combinations in the “B” area and a second database for the “A” area contains a record of combinations within a selected range such as −7 to 7. As a general rule in selecting the quantization table to be used, it is preferred, but not necessary, to select a quantization table that will produce a 7:1 compression ratio or higher on average.

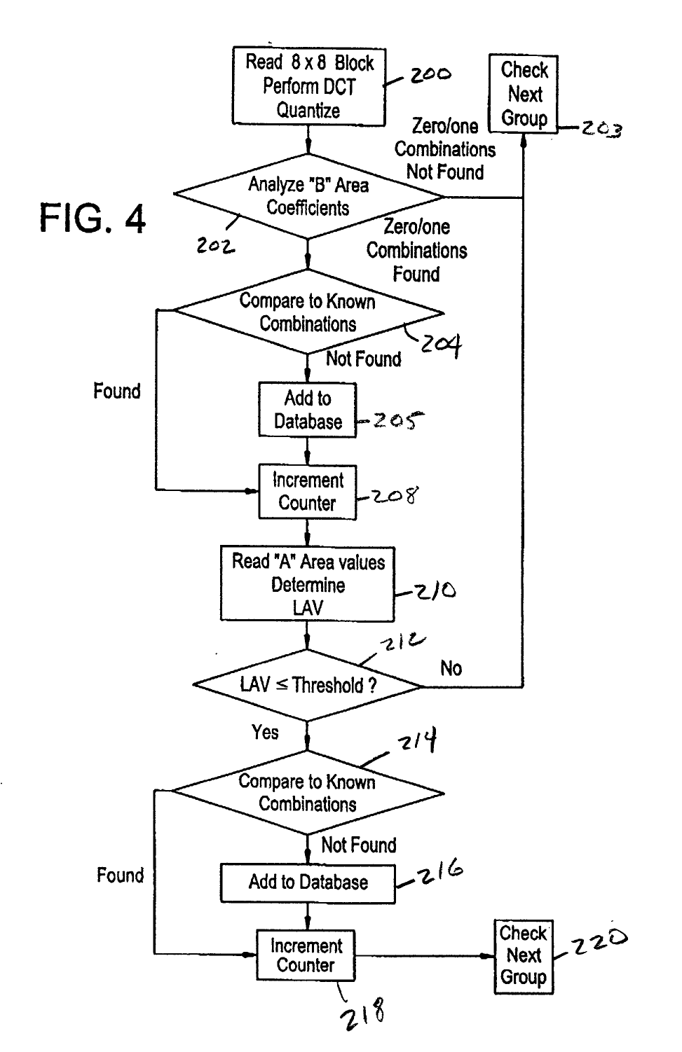

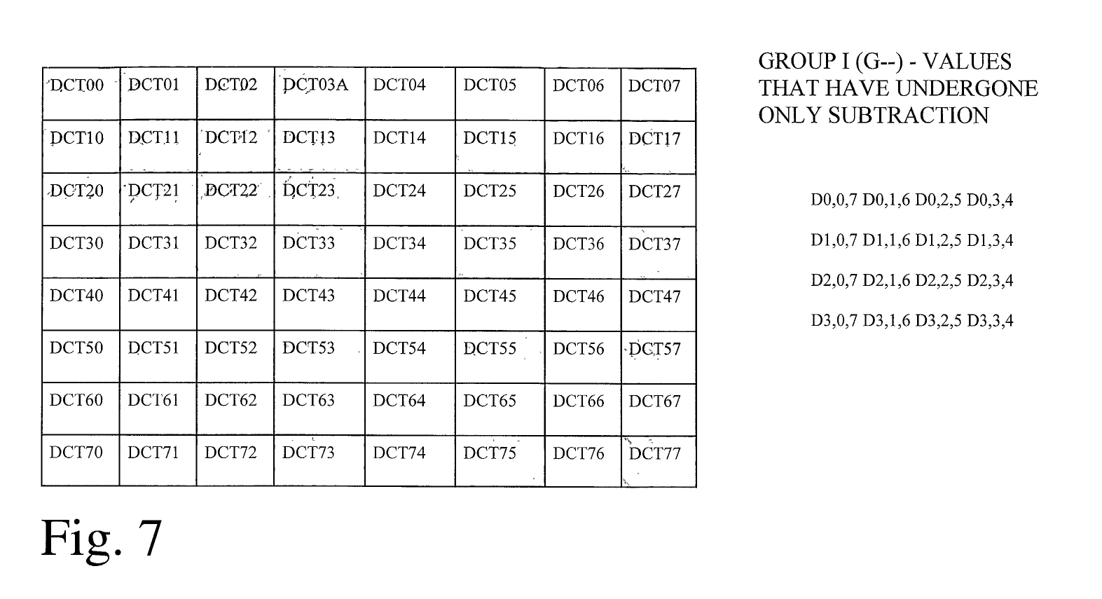

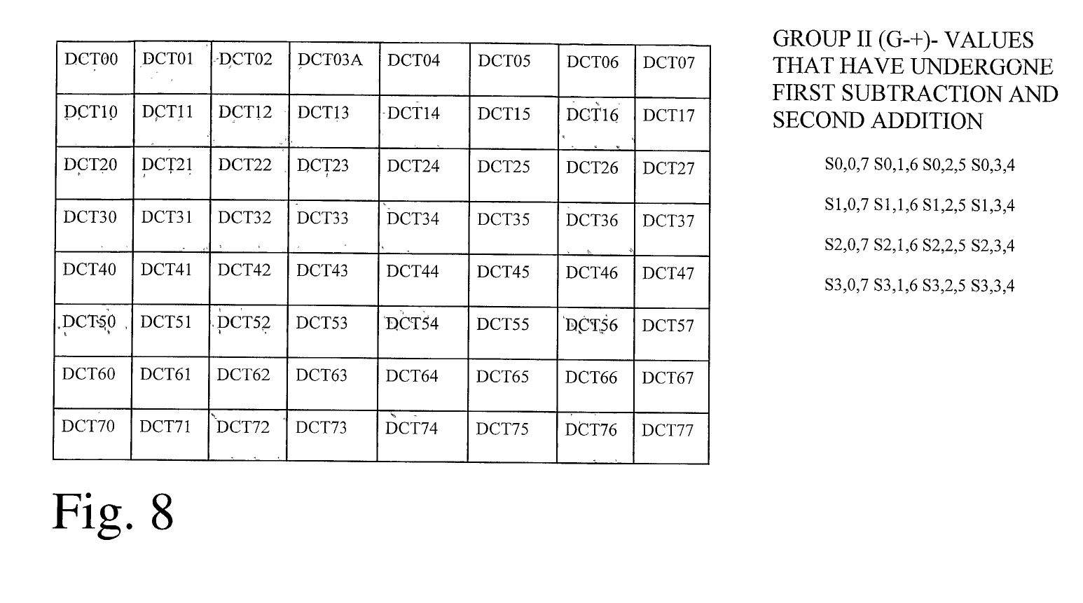

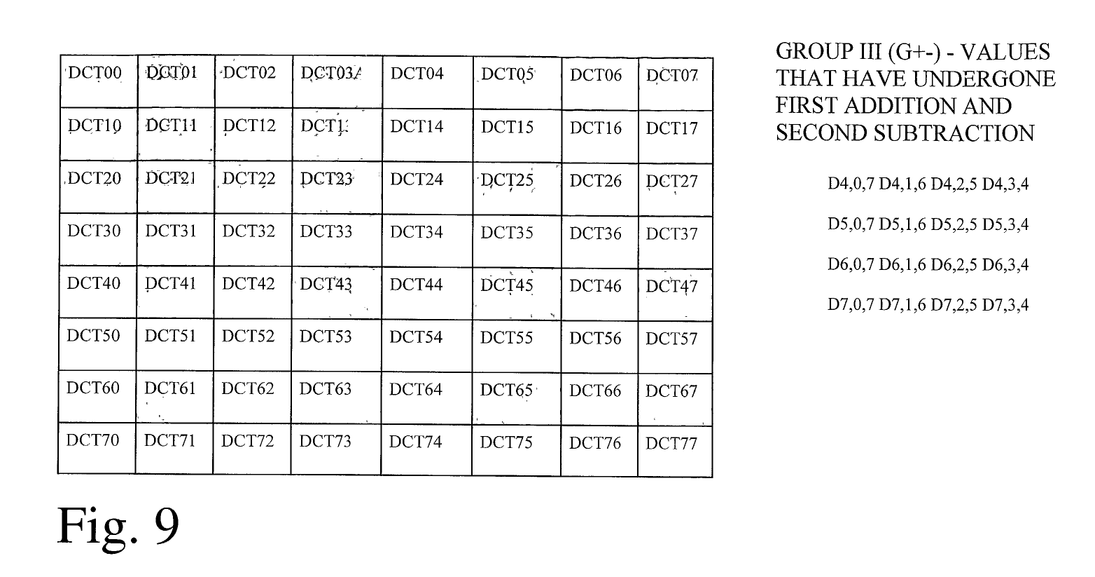

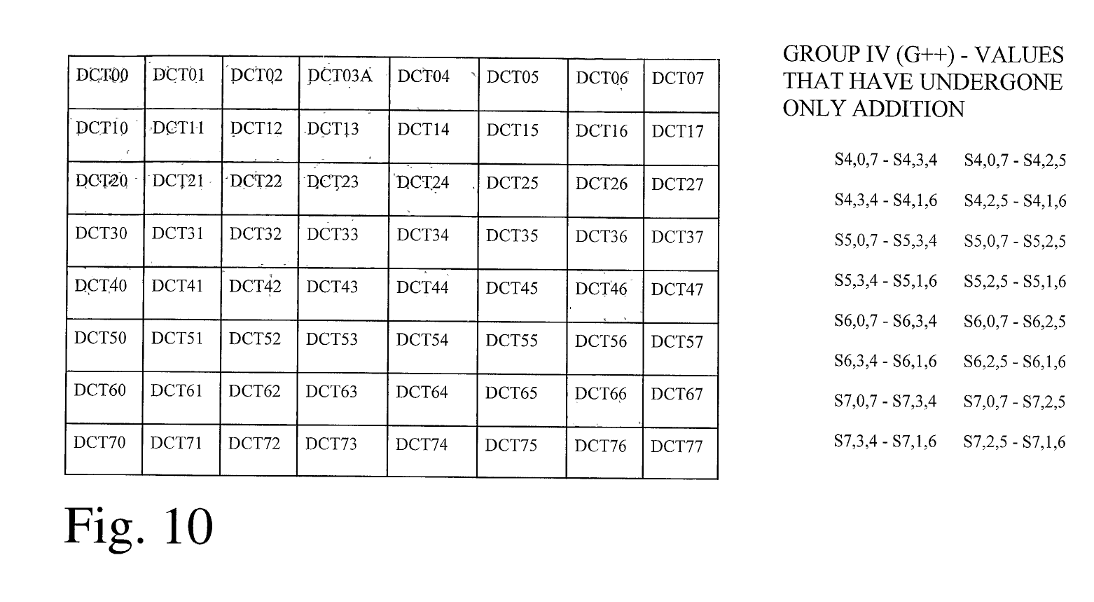

With reference to FIG. 4, the following subroutine is for one 8×8 data block taken from a color image. The 8×8 data block is read in and a conventional DCT process and quantization is performed on the data at step 200. The results of the transform are arranged into 4 groups G(−) (−), G(−) (+), G(+) (−), G(+) (+) where the DCT coefficients that make up each set correspond to the DCT coefficients in FIGS. 7-10.

Next the coefficients for each group from the “B” area are analyzed at step 202. If no zero-one combination is found the program returns to analyze the next Group at step 203. Else, if the 12 Coefficients that make up the “B” area produce a zero-one combination then the combination is compared to other found combinations at step 204. If the combination is not in the database, the combination is added to the “B” area database at step 205. Otherwise, if the combination already exists, a counter is incremented to indicated the number of times the combination has been encountered at step 208.

Next the “A” area is checked. The four values for the “A” area are read to determine the largest absolute value for the four “A” area components at step 210. If the value is less than or equal to a predetermined threshold value at step 212, for example, 7 is a good number. As discussed above, the choice for the threshold value may vary and may be constrained by memory limitations. If “no”, the program returns to analyze the next Group at step 203. Else, if “yes”, then the combination is compared to other found combinations at step 214. If the combination is new it is added into the “A” area database at step 216. If the combination is known, a counter is incremented to track the number of time the combination has been encountered at step 218. The program then continues to scan the next Group at step 220.

This routine is repeated for all of the 8×8 data blocks in the image that has been read and preferably for a number of images. Following the compilation of the database, the look-up tables may be generated. A good indicator of the number of images useful for building the tables corresponds to a reduction in the number of new images stored as indication by the total number of counters. When the number of new counters tapers-off, this generally indicates that a sufficient number of images have been read.

The process for creating the look-up table is repeated for each of the four groups. As indicated above, this process outlines the steps for an A,B quantization table corresponding to FIG. 6. For each database, establish a threshold percentage of values to be included in the look-up table. For example an 80% threshold is believed to provide a coverage of the common combinations. It is noted that the threshold percentage corresponds to the size of the look up table desired. A 100% threshold will require more memory to store the table than an 80% threshold. With this in mind, it may be necessary for some applications to choose a smaller threshold value due to memory constraints.

The following process is performed for each group of 16 values separately. First define the 16 values of a particular group as a 4×4 matrix in the following manner:

| | | | |
|---|---|---|---|
| V11 | V12 | V13 | V14 |
| V21 | V22 | V23 | V24 |
| V31 | V32 | V33 | V34 |
| V41 | V42 | V43 | V44 |

It has been discovered that there are two major considerations in the construction of a look-up table:

1. The number of operations required to pass through the table until a decision is made.

2. The size of the look-up table.

The two considerations are interrelated as the greater complexity of the database usually corresponds to a larger size. A particular system architecture can also influence the construction of the look-up table. For example, a hardware system equipped with a limited memory.

Using the database example discussed previously, there are now two databases that contain all 16-values-combinations that are going to be part of the look-up table.

There are two methods presented here of entering a new 16-values-combination into the look-up table. The two methods make use of the following discoveries on the nature and behavior of the 16 values of image data:

1. More than 95% of the combinations consists of 16 values in the range of −60 to 60.

2. More than 95% of the combinations of discovery 1 apply the following relationship:

For each column: j:1 . . . 4

|V1j−V2j|<=24

|V2j−V3j|<=24

|V3j−V4j|<=24

Between columns: j:1.3

|V1j−V1j+1|<=24

|V2j−V2j+1|<=24

|V3j−V3j+1|<=24

|V4j−V4j+1|<=24

|V1j−V1j+1|<=24

3. For any given column of 4 values in a particular group, the number of common combinations that will cover over 90% of the total sum of combinations will range from 64-1000 combinations depending on the manipulations done on the actual values and the desired level of accuracy.

For example: By quantizing the 16 values by a constant the value range is narrowed and also “converges” with similar combinations. A quantization value of 8 will maintain excellent accuracy and will decrease the number of common combinations for a particular column to around 256 (85% threshold). 90% threshold will double the number to around 500 combinations. In this instance, the threshold refer to the percentage of combinations recorded that are put into the database. An 80% threshold is preferred as it requires relatively little more memory than a 70% threshold. After the 80%-85% threshold range, it has been noted that the memory requirements for higher thresholds increase almost exponentially. Thus, 90% threshold would require considerably more memory. Those combinations not covered by the threshold are conventionally by the DCT engine.

4. In a similar manner to discovery 3: any combination of two columns (8 values) will give between 1000-6000 common combinations.

5. In a similar manner to discoveries 3,4: all 16 values will “converge” to between 4000-16000 combinations for a particular group.

6. The numbers presented in the discoveries 3-5 are exemplary and can vary greatly depending on the desired level of accuracy and the desired threshold, but they give a good idea of the order of magnitude we are talking about.

7. Every value in a particular group has an independent influence on the final result of the DCT. This is an inherent property of the DCT algorithm.

With reference to FIG. 5, the first method of entering a new combination into the look-up table is described below. 20

First, quantize the 16 values by a predefined constant at step 400. The constant can be 1 for no—quantization. The higher the quantization constant the smaller the range of results per value. However, a high quantization constant can cause noticeable inaccuracies between the prediction and the actual DCT transformation.

A quantization value of 8 will give excellent match between prediction results and the actual DCT transform while reducing the range of values to |7|, (the absolute value of 7).

By quantizing the values of a particular group, the range of values that will be used as entries into the look-up table are narrowed. It is obvious that the bigger the quantization, the smaller the range of values and the size of the look-up table. However, as the quantization increases, the accuracy of the prediction is decreased. Every quantization table will have its own quantization constant selected as a compromise between the size of the look-up table and the accuracy of the prediction. One can also make selective quantization on the 16 values of a particular group by taking into account the final quantization matrix and noticing (in the A,B case) that the “A area” is more sensitive to prediction errors. From the general formula of the DCT a determination of what values, from the 16 values of the group, have the greatest influence on the final 4 DCT coefficients in the “A area” can be obtained. For these values, a smaller quantization constant can be selected, and for the other values that mainly influence the “B area” results, a bigger quantization constant can be selected.

A general method for determining the optimized quantization constant is described:

1. Select a particular quantization matrix that will supply the desired compression ratio.

2. After the creation of the look-up tables, go over all the combinations contained in the look-up table and check each combination with all possible combinations that converge to this particular quantized combination.

3. Count the combinations that give a different result from the prediction.

4. If the ratio of error count/total count is bigger than a certain threshold (5% is a good number) than remove this particular combination from the look-up table.

5. It is worth noticing that “not all errors are created equal”. There are errors that are near the “border” of the final quantization constant and can be viewed as an accurate result. For example: If the final quantization constant is 16 and the final result of a certain quantized combination is 1 (meaning a range of results between 8-24 before the quantization by 16) and one of the unquantized combinations that converge to the quantized combination give a result of 7.9, it is still good enough to use for all practical purposes.

Every record in the look-up table is provided with the following information: A pointer to the next level in the look-up table or an “Exit” code (No match). The last level will contain the combination code or an “Exit” code at step 402.

Since there are 16 values to check, the look-up table is defined with 16 “layers” of records at step 404. The first layer consists of 15 records for the first value (V11 for example). These 15 records will cover the range from −7 to 7.

The second layer will theoretically contain 15*15 records and so on.

Every layer will also dismiss a lot of values that are not part of the common combination. For example, it is reasonable to assume for the second layer that from the 15*15 records, only 15*3 (average) will continue to the next level.

Now take advantage of an inherent property of the DCT algorithm: Every value has an independent influence on the final result of the DCT. By knowing this it has been realized to unite many records that have a similar influence on the final result.

Next, sum all record counters to give a total number of combinations inside the database at step 406.

Sort the records in the database in descending order (from the biggest counter to the smallest counter) at step 408.

Initialize a second general counter to zero at step 410.

Start adding combinations to the look-up table starting with the top record in the sorted database (the biggest counter). Add the record counter to the general counter at step 412.

Add the counter to the general counter at step 413.

Determine the ratio: general counter/Total number of combinations at step 414.

Check if this ratio is bigger than a certain threshold at step 416, for example 0.8 for 80%, if it is stop the process at step 418, else repeat steps 412-416 until completed.

For example: Take the first 2 values, V11 and V21, and look at all of the common combinations of these two values, it will be seen that a lot of the combinations have identical influence, for all practical matters, on the end result. So if we know that combination 0 1 and 1 0 (for V11 and V21) have the same influence, both will point to the same location in the next layer. This method will decrease the number of records in the look-up table to a manageable amount.

To better control the size of the look-up table, it is possible to divide the process into two or four stages that will use the same relatively small table: A two-stage process is described. The four-stage process is identical in structure but creates 4 intermediate values instead of two.

### Step 1

Build a look-up table to the first 8 values in a particular group. The result of the look-up table will be an intermediate code describing the influence of the first 8 values on the final 16 DCT results. Repeat the process on the last 8 values using the same table.

### Step 2

Combine the two intermediate codes into one result code via another table of intermediate combinations.

It is also possible to create a look-up table based on the results of the first set of addition/subtraction calculations performed by the DCT engine. However, it will be a bigger table because it is not possible to take advantage of the “vertical symmetry” of the data, only the “horizontal symmetry” (subtract/add per column). But it will save time on the computations performed by the DCT engine. The result codes of this process will contain information on 32 DCT values instead of 16 DCT values.

Application Specific Prediction Engines

In the selection of images for building the look-up table, it will be appreciated by those skilled in the art that a variety of graphic image types have different affects on the DCT engine. The ten images used as reference by the JPEG committee focused on natural images in the form of photographs in which the transition between different objects and colors in the image transition gradually. In contrast, graphics and art images or non-natural images usually offer abrupt transitions that offer distinct boundaries between shapes and colors. These images when processed by conventional JPEG may take longer to process for this reason. Images used by the medical profession in various types of imaging systems also have unique characteristics, where it is desirable to provide a prediction engine for a specific application, such as medical imaging, images representative of that application type are used to generate the combinations.

What has been disclosed is merely illustrative of the present invention. Other arrangements and methods can be implemented by those skilled in the art without departing from the spirit and scope of the present invention.

It will be understood that certain features and subcombinations are of utility and may be employed without reference to other features and subcombinations as they are outlined within the claims. While the preferred embodiment and application of the invention has been described, it is apparent to those skilled in the art that the objects and features of the present invention are only limited as set forth in the claims attached hereto.

What is claimed is:

1. A database compiler for reading a plurality of images comprising:
a discrete cosine transform engine including means for apportioning said data when uncompressed into a plurality of uncompressed blocks and means for converting at least one of said blocks to a DCT coefficient block;
means for apportioning said DCT coefficient block into a plurality of predetermined groups;
means for comprising data values from a predetermined group to a predetermined characteristic; and
means for storing each successful comparison.
